(19) United States
(12) Patent Application Publication
(10) Pub. No.: US 2004/0175974 A1
(43) Pub. Date: Sep. 9, 2004

(54) Electrical connector assembly with pick up cap protecting contacts

(76) Inventors: Hao-Yun Ma, Tu-Chen (TW); Ming-Lun Szu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/618,147

(22) Filed: Jul. 11, 2003

(30) Foreign Application Priority Data
Mar. 7, 2003 (TW) 92203517

(51) Int. Cl. H01R 13/44

(52) U.S. Cl. 439/135

(57) ABSTRACT

An electrical connector assembly includes an electrical connector (2) and a pick up cap (1) attached onto the connector. The connector includes a generally rectangular housing (21), a clip (24) pivotally engaged to the housing, and a number of electrical contacts (23) received in the housing. The housing includes a cavity (210) formed with a front side (211), a rear side (212) opposite to the front side, and a pair of opposite lateral sides (213) interconnecting the front side and the rear side. The pick up cap includes a planar body (10) with a smooth top surface (100) and a bottom surface thereof. In use, the pick up cap is mounted between the clip and the housing, therefore, it is close to the contacts and covers nearly all the exposed contacts, thereby providing the protection of the contacts.

### BACKGROUND OF THE INVENTION

1. Field of the Invention

The present invention relates to an electrical connector assembly, and particularly to a combined pick up cap and electrical connector in which the pick up cap is attached onto the electrical connector.

2. Description of the Prior Art

On many production lines, electronic components such as electrical connectors are accurately positioned on a printed circuit board (PCB) such as a motherboard by means of a vacuum suction device. Since an electrical connector typically has a multiplicity of through holes in a top portion thereof, a pick up cap has to be pre-attached on the electrical connector. The vacuum suction device is then able to engage on a flat top surface of the pick up cap, in order to reliably move and accurately position the electrical connector onto the PCB. This kind of pick up cap is shown in U.S. Pat. No. 6,413,111 to Pickles et al., dated Apr. 6, 1993.

Commonly, a Land Grid Array (LGA) socket comprises a housing mounted on a printed circuit board, a metal clip pivotably engaged on the housing, and a plurality of contacts secured in the housing. The metal clip has a window in the center. Each contact protrudes a predetermined height above a surface of the housing to contact with a Land Grid Package (LGP), and the exposed portions of the contacts are liable to be distorted or even damaged when they are impacted by a foreign object.

On a production line, the metal clip of the conventional LGA socket is rotated downwardly to a horizontal closed position. A pick up cap is then attached on the metal clip. The pick up cap provides a smooth top surface for a vacuum suction device to engage. Thus the electrical connector can be moved and accurately positioned onto a predetermined location of the PCB.

However, one problem with this type of pick up cap is that it is attached on the clip is relatively far from the exposed portions of the contacts. Foreign matter, such as wires used on the assembly line or a finger of an operator, is liable to enter a space between the metal clip and the housing. The exposed portions of the contacts are liable to be damaged and/or contaminated by such foreign matter.

In view of the above, a new electrical connector assembly with a pick up cap which overcomes the above-mentioned disadvantages is desired.

### SUMMARY OF THE INVENTION

Accordingly, an object of the present invention is to provide an electrical connector assembly having a pick up cap for providing a smooth top surface for a vacuum suction device, and for protecting contacts of an electrical connector of the electrical connector assembly.

To achieve the above-mentioned object, an electrical connector assembly in accordance with a preferred embodiment of the present invention comprises an electrical connector and a pick up cap attached onto the connector to provide a flat top surface for a vacuum suction device. The connector comprises a generally rectangular insulative housing, a clip pivotally engaged to the housing, and a plurality of electrical contacts received in the housing. The housing comprises a front side, a rear side opposite to the front side, and a pair of opposite lateral sides interconnecting the front side and the rear side. The front side, rear side and lateral sides cooperatively define a cavity for receiving a central processing unit (CPU) therein. A bottom portion of the housing under the cavity defines a multiplicity of passageways, the passageways receiving the contacts therein. A securing recess is defined in a middle portion of the front side, and a pair of spaced rear steps is defined in the rear side of the housing. A pair of spaced, rectangular lateral steps is formed in each lateral side of the housing.

The pick up cap comprises a planar body with a smooth top surface and a bottom surface thereof. The planar body comprises a head portion thereof corresponding to the securing recess of the housing, a pair of spaced tail portions at a rear edge thereof corresponding to the rear steps of the housing, and a pair of spaced lateral portions at each of opposite lateral sides thereof corresponding to respective lateral steps of the housing. A pair of spaced, parallel latch arms depends from a bottom surface of the head portion. In use, the pick up cap is mounted between the clip and the housing, therefore, it is close to the contacts and covers nearly all the exposed contacts, thereby providing effective protection for the contacts.

Other objects, advantages and novel features of the invention will become more apparent from the following detailed description when taken in conjunction with the accompanying drawings, in which:

### BRIEF DESCRIPTION OF THE DRAWINGS

FIG. 1 is a simplified, isometric view of an electrical connector of the electrical connector assembly in accordance with the preferred embodiment of the present invention;

FIG. 2 is a simplified, exploded isometric view of a housing of the electrical connector of FIG. 1 and a pick up cap of the electrical connector assembly in accordance with the preferred embodiment of the present invention;

FIG. 3 is an assembled view of FIG. 2;

FIG. 4 is an isometric view of the electrical connector assembly in accordance with the preferred embodiment of the present invention, showing a metal clip thereof in an open position; and

FIG. 5 is similar to FIG. 4, but showing the metal clip in a closed position.

### DETAILED DESCRIPTION OF THE PREFERRED EMBODIMENT OF THE INVENTION

Reference will now be made to the drawings to describe the present invention in detail.

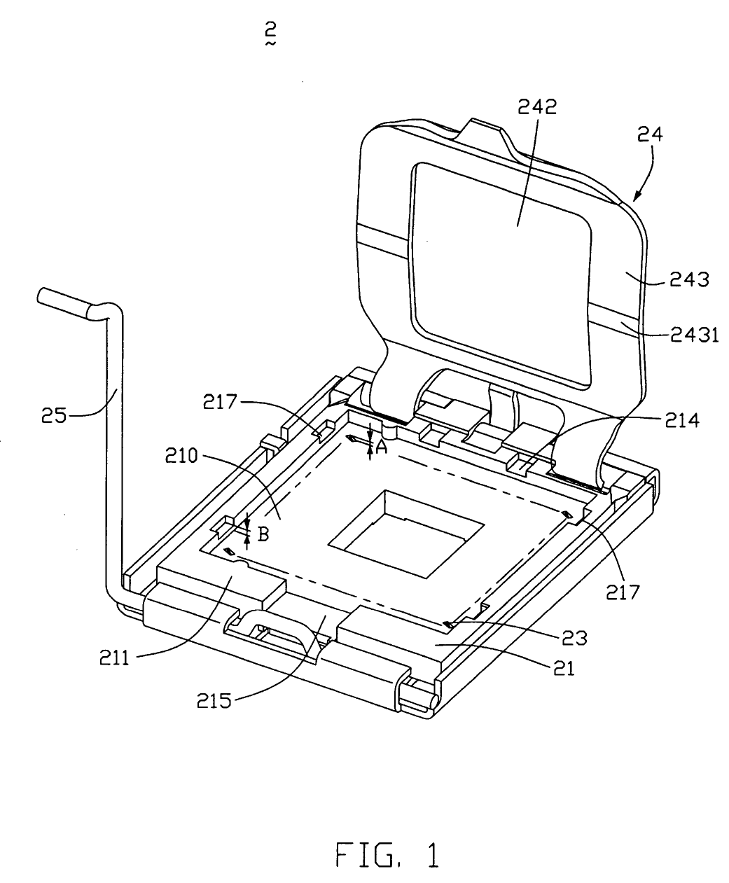

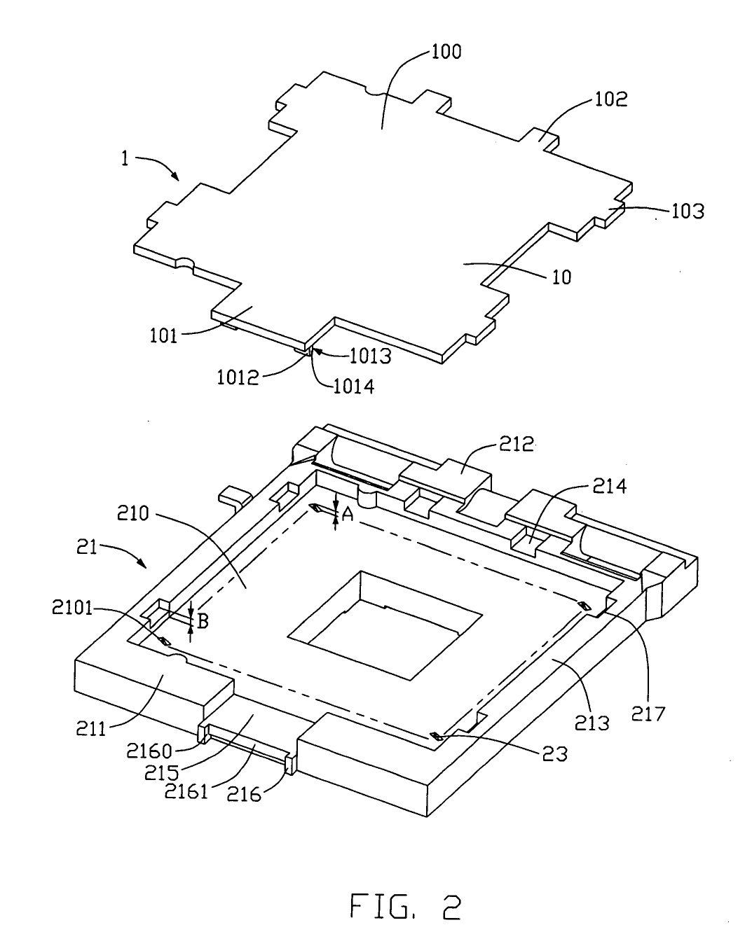

Referring to FIGS. 1-2, an electrical connector assembly of the present invention comprises an electrical connector 2 and a pick up cap 1. The electrical connector 2 comprises an insulative housing 21 grasped by a reinforcement metal frame (not labeled), a clip 24 pivotally attached to the housing 21, and a load lever 25 for pressing the clip 24 onto the housing 21. A plurality of contacts 23 is secured in the housing 21. The pick up cap 1 is attached onto the housing 21 to provide a flat top surface for the connector assembly, and to protect the contacts 23 of the electrical connector 2. The clip 24 defines a center window 242, and comprises two ribs 243 having two pressing portions 2431 respectively.

The housing 21 has a generally rectangular configuration, and a plurality of electrical contacts 23 received therein. The housing 21 comprises a front side 211, a rear side 212 opposite to the front side 211, and a pair of opposite lateral sides 213 interconnecting the front side 211 and the rear side 212. The front side 211, rear side 212 and lateral sides 213 cooperatively define a generally rectangular cavity 210 therebetween for receiving a central processing unit (CPU) (not shown) therein. A bottom portion of the housing 21 under the cavity 210 defines a multiplicity of passageways 2101, the passageways 2101 receiving the contacts 23 therein. Each contact 23 protrudes a predetermined height A above said bottom portion of the housing 21, for contacting the CPU.

A securing recess 215 is defined in a middle portion of the front side 211 of the housing 21. A pair of engaging bars 216 extends forwardly from the front side 211 at opposite ends of the securing recess 215 respectively. Each engaging bar 216 comprises an inside first engaging surface 2160. A second engaging surface 2161 is defined on the front side 211 between the first engaging surfaces 2160.

A pair of spaced rear steps 214 is formed in the rear side 212 of the housing 21. A pair of spaced lateral steps 217 is formed in each lateral side 213 of the housing 21, adjacent the cavity 210. The securing recess 215, rear steps 214, and lateral steps 217 all define respective top surfaces, and the top surfaces being a same height B above said bottom portion of the housing 21. In the preferred embodiment of the invention, height B is slightly greater than height A.

The pick up cap 1 has a planar body 10 having a smooth top surface 100. The planar body 10 comprises a head portion 101 at a front thereof corresponding to the securing recess 215 of the housing 21, a pair of spaced tail portions 102 at a rear edge thereof corresponding to the rear steps 214 of the housing 21, and a pair of spaced lateral portions 103 at each of opposite lateral sides thereof corresponding to respective lateral steps 217 of the housing 21. A pair of spaced, parallel latch arms 1012 depends from a bottom of the head portion 101. Each latch arm 1012 comprises a main inner surface 1013 and an outer side edge 1014, corresponding to the second engaging surface 2161 and a respective first engaging surface 2160 of the housing 21, respectively.

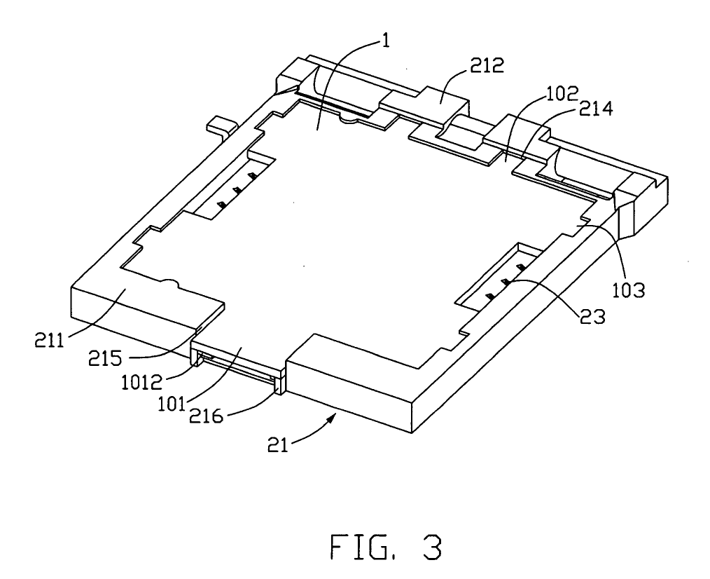

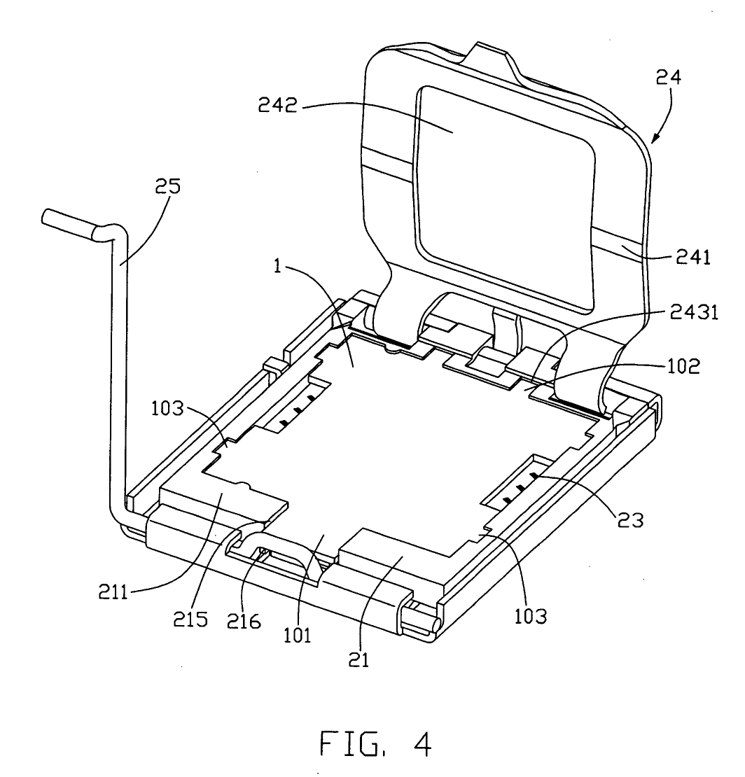

Referring also to FIGS. 3-4, in assembly, the clip 24 is rotated to a vertical open position. The pick up cap 1 is placed on the housing 21, and pressed downwardly. The tail portions 102 of the pick up cap 1 are supported on the rear steps 214 of the rear side 212, and the inner surfaces 1013 of the latch arms 1012 loosely contact a top edge portion of the second engaging surface 2161.

A front of the pick up cap 1 is pressed downwardly, and the latch arms 1012 deflect outwardly as they ride over said top edge portion. The bottom of the head portion 101 is attached on a top surface of the front side 211 in the securing recess 215, with the lateral portions 103 fittingly attached on the corresponding lateral steps 217, and the tail portions 102 fittingly attached on the corresponding rear steps 220. That is, the pick up cap 1 is supported by top surfaces of the housing 21 in the securing recesses 215, the rear steps 220, and the lateral steps 217. The inner surfaces 1013 of the latch arms 1012 resiliently abut against the second engaging surface 2161. The side edges 1014 of the latch arms 1012 fittingly abut the first engaging surfaces 2160. Thus, the pick up cap 1 is securely fastened on the connector 2. Because the distance B is greater than the distance A, the pick up cap 1 does not contact or press the exposed contacts 23. Rather, the pick up cap 1 protects the contacts 23 from being damaged or contaminated.

In use, the clip 24 is rotated to a horizontal closed position, and is fastened to the housing 21 by the load lever 25. The top surface of the pick up cap 1 faces the center window 242 of the clip 24. A vacuum suction device can pass through the center window 242 and engage on the top surface 100 of the pick up cap 1, for moving of the connector assembly to a desired location.

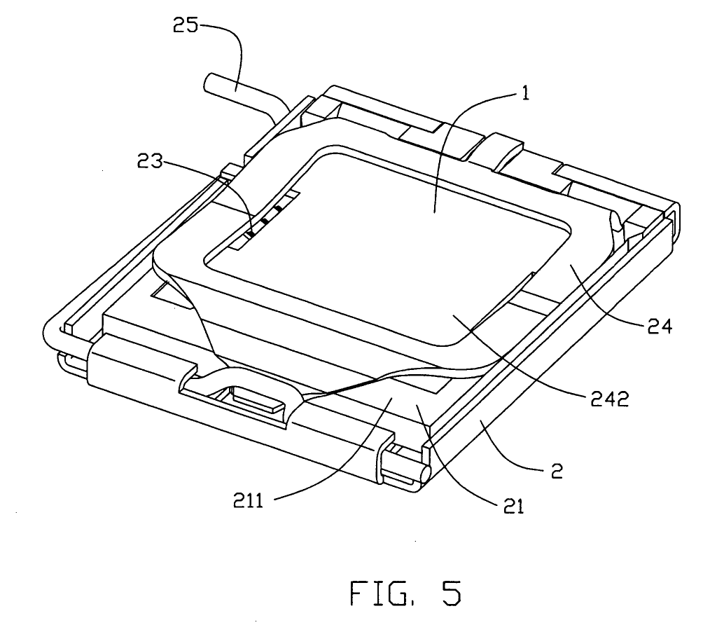

As shown in FIG. 5, the pick up cap 1 is disposed between the housing 21 and the clip 24. The pick up cap 1 is close to the exposed contacts 23, thereby providing effective protection for the contacts 23.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical connector assembly comprising:
an electrical connector comprising an insulative housing, a clip engaged on the housing, and a plurality of electrical contacts received in the housing, the contacts protruding from the housing;
a pick up cap engaged on the housing and comprising a planar body with a smooth top surface;
wherein the pick up cap is disposed between the housing and the clip;
whereby the pick up cap protects the contacts from damage or contamination.

2. The electrical connector assembly as claimed in claim 1, wherein the housing comprises a front side, a rear side, and a pair of lateral sides cooperatively defining a cavity therebetween.

3. The electrical connector assembly as claimed in claim 2, wherein the electrical contacts protrude a predetermined height above a bottom of the housing in the cavity.

4. The electrical connector assembly as claimed in claim 2, wherein a securing recess is defined in the front side, a plurality of spaced rear steps is provided in the rear side, and a plurality of spaced steps is provided in each lateral side.

5. The electrical connector assembly as claimed in claim 4, wherein the securing recess, the lateral steps and the rear steps define a same height, and said same height is greater than said predetermined height of the contacts protruding above the bottom of the housing.

6. The electrical connector assembly as claimed in claim 1, wherein the pick up cap comprises a head portion, a plurality of spaced tail portions, and a plurality of spaced lateral portions.

7. The electrical connector assembly as claimed in claim 6, wherein a pair of spaced, parallel latch arms depends from the head portion.

8. The electrical connector assembly as claimed in claim 1, wherein the clip defines a center window.

9. An electrical connector assembly comprising:
an electrical connector comprising a dielectric housing, and a plurality of conductive contacts received therein, the housing comprising a plurality of side walls cooperatively defining a cavity therebetween; and
a pick up cap comprising a planar body with a smooth top surface;
wherein the pick up cap is disposed in the cavity and engages with side walls of the cavity;
whereby the pick up cap provides protection for the contacts.

10. The electrical connector assembly as claimed in claim 9, wherein the contacts protrude a predetermined height above a bottom of the housing in the cavity.

11. The electrical connector assembly as claimed in claim 9, wherein the side walls of the housing are comprised in a front side, a rear side, and a pair of lateral sides of the housing.

12. The electrical connector assembly as claimed in claim 11, wherein a securing recess is defined in the front side, a pair of spaced rear steps is provided in the rear side, and a pair of spaced lateral steps are provided in each lateral side.

13. The electrical connector assembly as claimed in claim 12, wherein the securing recess, the lateral steps and the rear steps define a same height, and said same height is greater than said predetermined height of the contacts protruding above the bottom of the housing.

14. The electrical connector assembly as claimed in claim 9, wherein the pick up cap comprises a head portion, a pair of spaced tail portions, and a plurality of spaced lateral portions.

15. The electrical connector assembly as claimed in claim 14, wherein a pair of spaced, parallel latch arms depends from the head portion.

16. An electrical connector assembly comprising:
a housing assembly defining an upper face thereon;
a plurality of contacts disposed in the housing assembly;
a pick up cap mounted upon the upper face and defining an upward top surface thereon; and
a moveable fastening device attached to the housing assembly and defining an opening; wherein
the fastening device is moved to either an open position to allow the pick up cap to be downwardly seated upon the housing, or a closed position to cooperate with the housing assembly to sandwich the pick up cap therebetween for holding the pick up cap in position without upward withdrawal under a condition that said opening exposes the upward top surface of said pick up cap to an exterior in a vertical direction for suction.

17. The assembly as claimed in claim 16, wherein said housing assembly includes a reinforcement metal frame.

18. An electrical connector assembly comprising:
an insulative housing assembly defining an upper face thereon;
a plurality of contacts disposed in the housing assembly with upper contact portions extending upwardly above the upper face with a first distance; and
a pick up cap mounted upon the upper face and defining an planar body with an upward top surface thereon; wherein
an undersurface of said planar body is spaced from said upper face with a second distance which is slightly larger than said first distance so as to protectively have said upper contact portions closely hidden under said planar body without damage during handling.

19. The assembly as claimed in claim 18, wherein said contacts are arranged in matrix, and said pick up cap encloses substantially all of said contacts.
